(19) United States
(12) Patent Application Publication
(10) Pub. No.: US 2022/0292565 A1
(43) Pub. Date: Sep. 15, 2022

(54) PROCESSING DEVICE, AND PROCESSING METHOD

(71) Applicant: NEC Corporation, Minato-ku, Tokyo (JP)

(72) Inventors: Takami SATO, Tokyo (JP); Kota IWAMOTO, Tokyo (JP); Soma SHIRAISHI, Tokyo (JP)

(73) Assignee: NEC Corporation, Minato-ku, Tokyo (JP)

(21) Appl. No.: 17/635,484

(22) PCT Filed: Aug. 22, 2019
(86) PCT No.: PCT/JP2019/032810

§ 371 Date: Feb. 15, 2022

(51) Int. Cl. G06Q 30/06

(52) U.S. Cl. CPC G06Q 30/0625

(57) ABSTRACT

The present invention provides a processing apparatus (10) including: an acquisition unit (11) acquiring a shelf image including a shelf on which a product is displayed; a retrieval unit (12) retrieving, in the shelf image, a product registered in a product database, based on an image of each of a plurality of products registered in the product database; a determination unit (13) determining existence of a difference between an image of a retrieved product in the shelf image and an image of a retrieved product registered in the product database; and a processing unit (14) notifying a product for which a difference is determined to exist.

### TECHNICAL FIELD

The present invention relates to a processing apparatus, a processing method, and a program.

### BACKGROUND ART

Patent Documents 1 to 3 disclose technologies for capturing images of a product to be checked out from a plurality of directions by a plurality of cameras in a technology for recognizing and registering a product to be checked out, based on a captured image of the product to be checked out and preregistered reference images of products.

Patent Document 4 discloses a technology for capturing images of a plurality of appearances of a product to be checked out by using mirrors in the technology for recognizing and registering a product to be checked out, based on a captured image of the product to be checked out and preregistered reference images of products.

Patent Document 5 discloses a technology for associating an image generated by a camera with product identification information read by a barcode reader.

### RELATED DOCUMENT

### Patent Document

Patent Document 1: Japanese Patent Application Publication No. 2017-220198

Patent Document 2: Japanese Patent Application Publication No. 2017-62703

Patent Document 3: Japanese Patent Application Publication No. 2016-110537

Patent Document 4: International Application Publication No. WO 2015/140855

Patent Document 5: Japanese Patent Application Publication No. 2004-30409

### DISCLOSURE OF THE INVENTION

### Technical Problem

In the technology for recognizing and registering a product to be checked out, based on a captured image of the product to be checked out and preregistered reference images of products, the reference images of the products need to be preregistered in a database. Then, the database needs to be updated according to a design change in a product package due to a renewal, addition of a product handled at a store, and the like. Conventionally, a means for easily recognizing a product a reference image of which is to be updated and registered has not existed. None of Patent Documents 1 to 5 describes or suggests the issue and a solution thereof.

An object of the present invention is to provide a technology for easily recognizing a product a reference image of which is to be updated and registered.

### Solution to Problem

The present invention provides a processing apparatus including:

an acquisition means for acquiring a shelf image including a shelf on which a product is displayed;

a retrieval means for retrieving, in the shelf image, a product registered in a product database, based on an image of each of a plurality of products registered in the product database;

a determination means for determining existence of a difference between an image of a retrieved product in the shelf image and an image of the retrieved product registered in the product database; and

a processing means for notifying a product for which a difference is determined to exist.

Further, the present invention provides a processing method including, by a computer:

acquiring a shelf image including a shelf on which a product is displayed;

retrieving, in the shelf image, a product registered in a product database, based on an image of each of a plurality of products registered in the product database;

determining existence of a difference between an image of a retrieved product in the shelf image and an image of the retrieved product registered in the product database; and

notifying a product for which a difference is determined to exist.

Further, the present invention provides a program causing a computer to function as:

an acquisition means for acquiring a shelf image including a shelf on which a product is displayed;

a retrieval means for retrieving, in the shelf image, a product registered in a product database, based on an image of each of a plurality of products registered in the product database;

a determination means for determining existence of a difference between an image of a retrieved product in the shelf image and an image of the retrieved product registered in the product database; and

a processing means for notifying a product for which a difference is determined to exist.

Further, the present invention provides a processing apparatus including:

an acquisition means for acquiring a shelf image including a shelf on which a product is displayed;

a retrieval means for retrieving, in the shelf image, a product registered in a product database, based on an image of each of a plurality of products registered in the product database; and

a registration means for determining an area in which a product not registered in the product database out of one or more products included in the shelf image exists and registering, in the product database, an image inside a determined area.

Further, the present invention provides a processing method including, by a computer:

acquiring a shelf image including a shelf on which a product is displayed;

retrieving, in the shelf image, a product registered in a product database, based on an image of each of a plurality of products registered in the product database; and

determining an area in which a product not registered in the product database out of one or more products included in the shelf image exists and registering, in the product database, an image inside a determined area.

Further, the present invention provides a program causing a computer to function as:

an acquisition means for acquiring a shelf image including a shelf on which a product is displayed;

a retrieval means for retrieving, in the shelf image, a product registered in a product database, based on an image of each of a plurality of products registered in the product database; and

a registration means for determining an area in which a product not registered in the product database out of one or more products included in the shelf image exists and registering, in the product database, an image inside a determined area.

### Advantageous Effects of Invention

The present invention provides a technology for easily recognizing a product a reference image of which is to be updated and registered.

### BRIEF DESCRIPTION OF THE DRAWINGS

The aforementioned object, other objects, features and advantages will become more apparent by the following preferred example embodiments and accompanying drawings.

FIG. 1 is an example of a functional block diagram of a processing apparatus according to the present example embodiment.

FIG. 2 is a diagram illustrating an example of a hardware configuration of the processing apparatus according to the present example embodiment.

FIG. 3 is a diagram schematically illustrating an example of a shelf image.

FIG. 4 is a diagram schematically illustrating an example of information processed by the processing apparatus according to the present example embodiment.

FIG. 5 is a diagram schematically illustrating an example of information output by the processing apparatus according to the present example embodiment.

FIG. 6 is a flowchart illustrating an example of a flow of processing in the processing apparatus according to the present example embodiment.

FIG. 7 is a flowchart illustrating an example of a flow of processing in the processing apparatus according to the present example embodiment.

FIG. 8 is an example of a functional block diagram of a processing apparatus according to the present example embodiment.

FIG. 9 is a diagram schematically illustrating an example of information output by the processing apparatus according to the present example embodiment.

FIG. 10 is an example of a functional block diagram of a processing apparatus according to the present example embodiment.

### DESCRIPTION OF EMBODIMENTS

### First Example Embodiment

A processing apparatus according to the present example embodiment determines existence of a difference between an appearance of each product indicated by a shelf image in which an image of a shelf in a store is captured and an appearance of each product indicated by an image registered in a product database and notifies a user of a product for which a difference is determined to exist. Details will be described below.

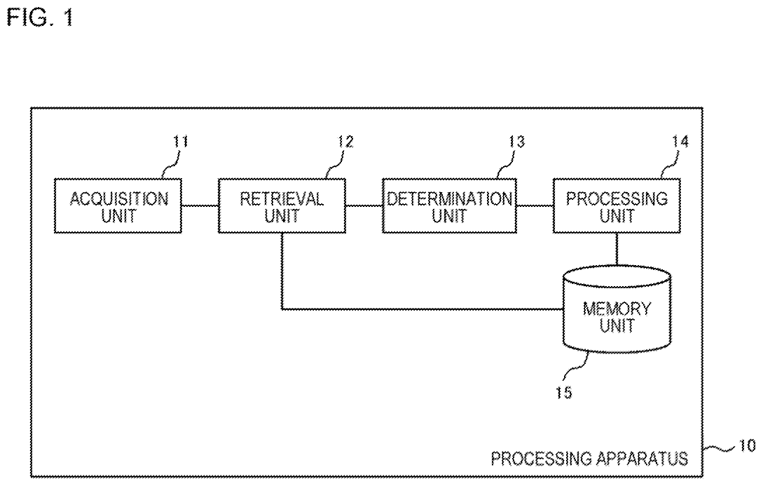

FIG. 1 illustrates an example of a functional block diagram of a processing apparatus 10. As illustrated, the processing apparatus 10 includes an acquisition unit 11, a retrieval unit 12, a determination unit 13, a processing unit 14, and a memory unit 15. Note that the processing apparatus 10 may not include the memory unit 15. In this case, an external apparatus configured to be communicable with the processing apparatus 10 includes the memory unit 15.

Each functional unit in the processing apparatus 10 is provided by any combination of hardware and software centered on a central processing unit (CPU), a memory, a program loaded in the memory, a storage unit [capable of storing not only a program previously stored in a shipping stage of the apparatus but also a program downloaded from a storage medium, such as a compact disc (CD), or a server or the like on the Internet] storing the program, such as a hard disk, and a network connection interface that are included in any computer. Then, it should be understood by a person skilled in the art that various modifications to the implementation method and the apparatus can be made.

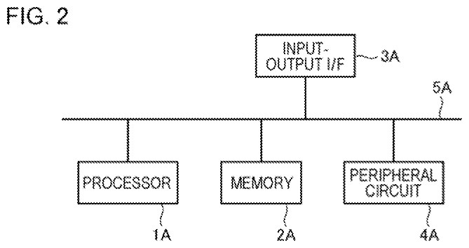

FIG. 2 is a block diagram illustrating a hardware configuration of the processing apparatus 10. As illustrated in FIG. 2, the processing apparatus 10 includes a processor 1A, a memory 2A, an input-output interface 3A, a peripheral circuit 4A, and a bus 5A. The peripheral circuit 4A includes various modules. The processing apparatus 10 may not include the peripheral circuit 4A. Note that the processing apparatus 10 may be configured with a plurality of physically and/or logically separated apparatuses or may be configured with a single physically and/or logically integrated apparatus. When the processing apparatus 10 is configured with a plurality of physically and/or logically separated apparatuses, each of the plurality of apparatuses may include the aforementioned hardware configuration.

The bus 5A is a data transmission channel for the processor 1A, the memory 2A, the peripheral circuit 4A, and the input-output interface 3A to transmit and receive data to and from one another. Examples of the processor 1A include arithmetic processing units such as a CPU and a graphics processing unit (GPU). Examples of the memory 2A include memories such as a random access memory (RAM) and a read only memory (ROM). For example, the input-output interface 3A includes an interface for acquiring information from an input apparatus, an external apparatus, an external server, an external sensor, and a camera, and an interface for outputting information to an output apparatus, an external apparatus, and an external server. Examples of the input apparatus include a keyboard, a mouse, a microphone, a physical button, and a touch panel. Examples of the output apparatus include a display, a speaker, a printer, and a mailer. The processor 1A can issue an instruction to each module and operate based on the operation result of the module.

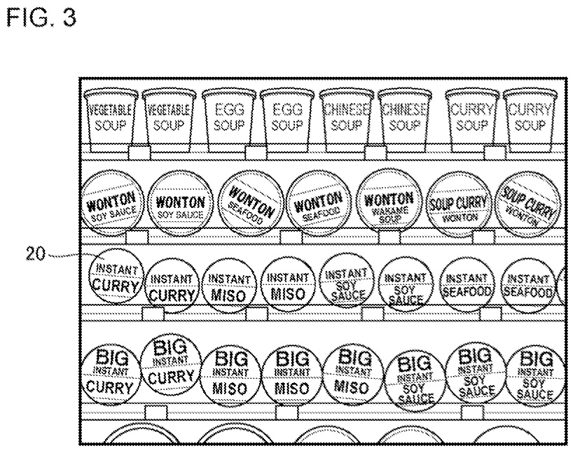

Returning to FIG. 1, the acquisition unit 11 acquires a shelf image including a shelf on which products are displayed. FIG. 3 schematically illustrates an example of a shelf image. The illustrated shelf image illustrates a scene in which a plurality of products 20 are displayed on a shelf

For example, a plurality of cameras may be installed in a store in such a way as to be positioned and directed to capture images of a plurality of areas in a plurality of shelves. Then, the camera may capture an image of a shelf at a predetermined timing and transmit the captured shelf image to the processing apparatus 10. The predetermined timing at which the camera captures an image may be a timing determined in advance. For example, the predetermined timing is considered to be “once a day at a predetermined time” or “a plurality of times a day at predetermined times.” The predetermined time may be immediately after a scheduled time when a new product is delivered to a store and display of the product on a shelf is completed. Further, the predetermined timing at which the camera captures an image may be a timing when an operator (such as a clerk) inputs an image capture instruction. In this case, the operator may input the image capture instruction to any apparatus (such as the processing apparatus 10, a smartphone, a personal computer, or a tablet terminal). Then, the any apparatus may transmit the input image capture instruction to the camera.

In addition, an operator may manually capture images of a plurality of areas in a plurality of shelves while carrying a camera or a mobile terminal equipped with a camera function (such as a tablet terminal, a smartphone, or a mobile phone) and moving inside a store. In addition, a robot equipped with the camera function and a moving means may capture images of a plurality of areas in a plurality of shelves while moving inside a store. Then, captured shelf images may be input to the processing apparatus 10 by any means. Note that the camera, the mobile terminal equipped with the camera function, or the robot may be equipped with a communication function of communicating with the processing apparatus 10 through a communication network. Then, the camera, the mobile terminal equipped with the camera function, or the robot may transmit shelf images to the processing apparatus 10 through the communication network. The processing apparatus 10 may function as a server (such as a cloud server).

Note that “acquisition” herein may include “the apparatus getting data stored in another apparatus or a storage medium (active acquisition)” in accordance with a user input or an instruction by a program, such as reception as a result of making a request or an inquiry to another apparatus, and readout as a result of accessing another apparatus or a storage medium. Further, “acquisition” may include “inputting data output from another apparatus to the apparatus (passive acquisition)” in accordance with a user input or an instruction by a program, such as receiving delivered (or, for example, transmitted or push notified) data. Further, “acquisition” may include selective acquisition from received data or information, and “generating new data by data editing (such as conversion to text, data sorting, partial data extraction, and file format change) or the like and acquiring the new data.”

Returning to FIG. 1, the retrieval unit 12 retrieves, in a shelf image, a product registered in a product database, based on images of a plurality of products registered in the product database. The retrieval unit 12 can retrieve, in a shelf image, a product registered in the product database by pattern matching based on the images of the plurality of products registered in the product database. For example, by retrieving an area in a shelf image for which a degree of similarity with an image of each product registered in the product database is equal to or greater than a predetermined value M1, the retrieval unit 12 can determine an area in the shelf image in which the product exists. For example, a degree of similarity may be indicated by a value ranging from 0 to 100% (similarity increases as the value approaches 100%) or a value ranging from 0 to 1 (similarity increases as the value approaches 1) or may be represented by another technique. While details of M1 are a matter of design, for example, when a degree of similarity is indicated by a value ranging from 0 to 100%, M1 may take any value between 80 and 90%. By adjusting M1 to a suitable value, not only an area matching an image of a product registered in the product database but also a very similar area can be retrieved in a shelf image. Therefore, when a product a product package design of which is slightly changed due to a renewal or the like is included in a shelf image and, at the same time, a product image before the product package design change is registered in the product database, an area in which the product after the design change exists can be retrieved by retrieval based on the product image before the design change.

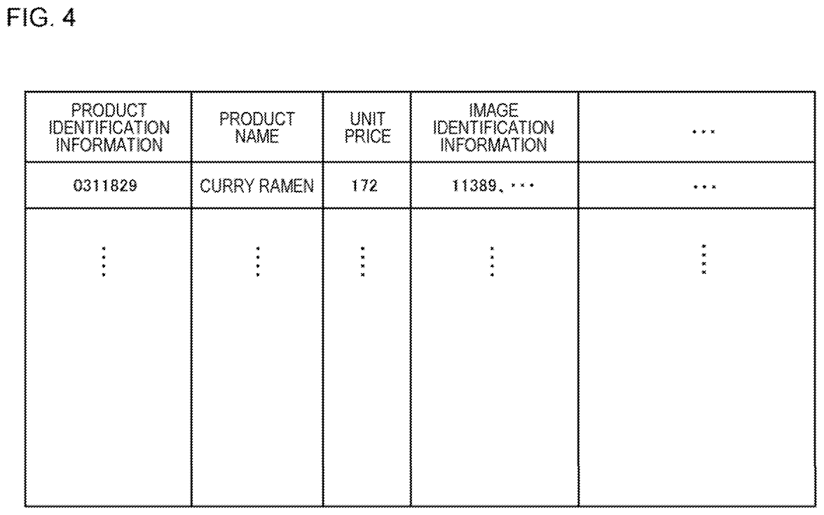

FIG. 4 schematically illustrates an example of information registered in the product database. In the illustrated product database, product identification information for distinguishing a plurality of products from one another, a product name, a unit price, and identification information of an appearance image (such as an image file name) of each product are associated with one another. Note that the product database may include another type of information. The memory unit 15 stores the information. For example, the product database is used in checkout processing by a point of sales (POS).

Returning to FIG. 1, the determination unit 13 determines existence of a difference between an image of a retrieved product in a shelf image and an image of the retrieved product registered in the product database (existence of a difference between appearances of a product).

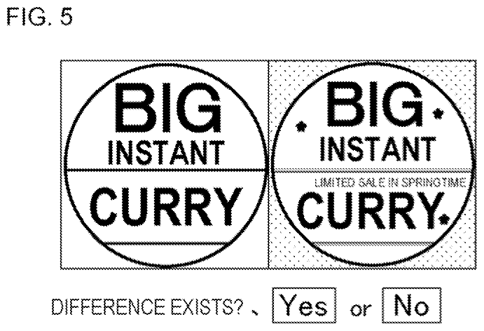

Specifically, the determination unit 13 causes a display apparatus to display an image of a retrieved product in a shelf image and an image of the retrieved product registered in the product database. Then, the determination unit 13 accepts a user input indicating existence of a difference between the two images. For example, the determination unit 13 causes the display apparatus to display a screen in which the two images are placed side by side and a UI part for accepting a user input indicating existence of a difference is displayed, as illustrated in FIG. 5. The image of the retrieved product in the shelf image may be an image acquired by extracting only an area in which the retrieved product exists from the shelf image. The display apparatus may be a display in the processing apparatus 10 or an external apparatus configured to be communicable with the processing apparatus 10 [for example, a mobile terminal operated by an operator (such as a tablet terminal, a smartphone, or a mobile phone), a personal computer, or a store terminal in a backyard of a store). Note that, when the display apparatus is the external apparatus, the external apparatus displays the aforementioned screen illustrated in FIG. 5 and accepts a user input indicating existence of a difference. Then, the external apparatus transmits the content of the accepted user input to the processing apparatus 10. In other words, the determination unit 13 accepts a user input indicating existence of a difference through the external apparatus.

Note that the determination unit 13 may display a degree of similarity between the two images on the screen illustrated in FIG. 5. Further, the determination unit 13 may display a correspondent line linking parts determined to correspond to each other by pattern matching (matching parts) on the screen illustrated in FIG. 5. Further, the determination unit 13 may display the number of the aforementioned correspondent lines on the screen illustrated in FIG. 5.

Thus, the determination unit 13 can generate a screen allowing easy comparison between an image generated by capturing an image of each displayed product and an image of the product registered in the product database and provide the screen for an operator. Then, the determination unit 13 can accept a user input indicating existence of a difference between the two images from the operator.

Returning to FIG. 1, the processing unit 14 notifies an operator of a product for which a difference is determined to exist. For example, the processing unit 14 registers a product for which a difference is determined to exist. Then, the processing unit 14 notifies an operator of the registered content at any timing.

For example, items in the product database may include a difference existence flag for identifying a product for which a difference is determined to exist. Then, the processing unit 14 may set the difference existence flag for a product for which a difference is determined to exist. An operator performs input for checking a product for which a difference is determined to exist to the processing apparatus 10 at any timing. The processing unit 14 checks the product database in response to the operation of the operator and notifies the operator of a product for which the difference existence flag is set, that is, a product for which a difference is determined to exist.

In addition, the processing unit 14 may transmit information for identifying a product for which a difference is determined to exist (such as a product name) to a mobile terminal operated by the operator (such as a tablet terminal, a smartphone, or a mobile phone), a store terminal in a backyard of a store, or the like and cause the information to be displayed.

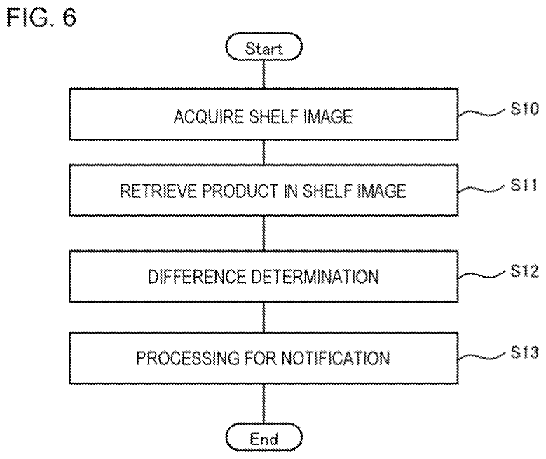

Next, an example of a flow of processing in the processing apparatus 10 will be described by using a flowchart in FIG. 6.

First, the acquisition unit 11 acquires a shelf image including a shelf on which products are displayed (S10). For example, the acquisition unit 11 acquires a shelf image as illustrated in FIG. 3.

Next, the retrieval unit 12 retrieves, in the shelf image, a product registered in the product database, based on images of a plurality of products registered in the product database (S11). For example, by retrieving, by pattern matching based on images of a plurality of products registered in the product database, an area in the shelf image for which a degree of similarity with an image of each product registered in the product database is equal to or greater than a predetermined value M1, the retrieval unit 12 determines an area in the shelf image in which the product exists. By adjusting M1 to a suitable value, not only an area matching an image of each product registered in the product database but also a very similar area can be retrieved in the shelf image. Therefore, when a product a product package design of which is slightly changed due to a renewal or the like is included in the shelf image and, at the same time, a product image before the product package design change is registered in the product database, an area in which the product after the design change exists can be retrieved by retrieval based on the product image before the design change.

Next, the determination unit 13 determines existence of a difference between an image of the retrieved product in the shelf image and an image of the retrieved product registered in the product database (S12).

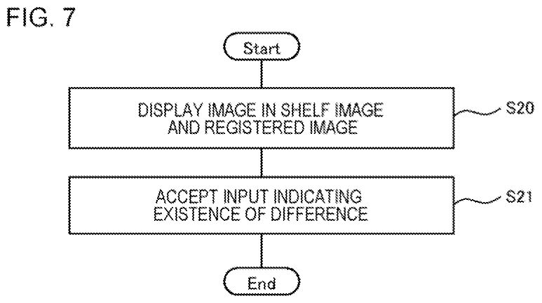

An example of a flow of the processing in S12 will be described by using a flowchart in FIG. 7. First, the determination unit 13 causes the display apparatus to display the image of the retrieved product in the shelf image and the image of the retrieved product registered in the product database, as illustrated in FIG. 5 (S20). Then, the determination unit 13 accepts a user input indicating existence of a difference between the two images (S21). When a plurality of products are retrieved in the shelf image acquired in S10, the determination unit 13 may perform the processing in S20 and S21 for each retrieved product.

Returning to FIG. 6, after S12, the processing unit 14 performs processing for notifying an operator of the product for which a difference is determined to exist (S13). For example, the processing unit 14 registers the product for which a difference is determined to exist. Then, the processing unit 14 notifies the operator of the registered content at any subsequent timing.

A modified example of the present example embodiment will be described. The processing unit 14 may register, in the product database, the image of the product in the shelf image for which a difference is determined to exist. Thus, the image of the product in the product database can be tentatively updated based on the shelf image until the operator captures an image of the product, based on a predetermined image capture condition, in response to the aforementioned notification and updates the image in the product database. As a result, precision of recognition processing in the processing of recognizing and registering a product to be checked out can be improved.

The processing apparatus 10 according to the present example embodiment described above can retrieve each product from a shelf image including a shelf on which products are displayed and can determine whether a difference exists between an image of the retrieved product in the shelf image and an image registered in the product database (existence of a product package design change). The aforementioned determination can be made based on comparison between the image of the product actually displayed on the shelf and the image registered in the product database, and therefore existence of a product package design change can be highly precisely and relatively easily determined.

Further, the processing apparatus 10 can display an image of a retrieved product in a shelf image and an image registered in the product database side by side and accept an input about whether a difference exists between the two images from an operator, as illustrated in FIG. 5. In this case, an operation to be performed by the operator is simply comparing the two displayed images and inputting whether a difference exists. Thus, the processing apparatus 10 according to the present example embodiment enables determination of existence of a product package design change by a relatively simple operation by an operator.

Further, the processing apparatus 10 can display an image of a retrieved product in a shelf image and an image registered in the product database side by side as illustrated in FIG. 5 and, in addition, can display a degree of similarity between the two displayed images, display a correspondent line linking parts determined to correspond to each other by pattern matching (matching parts), and display the number of the aforementioned correspondent lines. With such supplementary information, an operator can highly precisely and relatively easily determine whether a difference exists between the two images.

### Second Example Embodiment

A configuration of a determination unit 13 in a processing apparatus 10 according to the present example embodiment differs from that according to the first example embodiment. The difference will be described below.

An example of a functional block diagram of the processing apparatus 10 is illustrated in FIG. 1. The processing apparatus 10 includes an acquisition unit 11, a retrieval unit 12, the determination unit 13, a processing unit 14, and a memory unit 15. Note that the processing apparatus 10 may not include the memory unit 15. In this case, an external apparatus configured to be communicable with the processing apparatus 10 includes the memory unit 15.

The determination unit 13 does not perform the aforementioned processing of determining existence of a difference on a product for which a degree of similarity in appearance between an image in a shelf image and an image registered in the product database satisfies a predetermined condition out of products retrieved by the retrieval unit 12. Then, the determination unit 13 performs the aforementioned processing of determining existence of a difference only on a product not satisfying the predetermined condition out of the retrieved products.

The predetermined condition is “a degree of similarity in appearance between an image in a shelf image and an image registered in the product database being equal to or greater than a predetermined value M2 (where M2>M1).” While details of M1 and M2 are a matter of design, for example, when a degree of similarity is indicated by a value ranging from 0 to 100%, M1 may take any value between 80 and 90%, and M2 may take any value equal to or greater than 98%.

When the degree of similarity is very high, a difference between the image in the shelf image and the image registered in the product database is estimated to be nonexistent. By omitting the aforementioned determination processing by the determination unit 13 for such a product, loads on the computer and an operator can be lightened.

The remaining configuration of the determination unit 13 is similar to that according to the first example embodiment. Further, configurations of the acquisition unit 11, the retrieval unit 12, the processing unit 14, and the memory unit 15 are similar to those according to the first example embodiment. Furthermore, an example of a hardware configuration of and an example of a flow of processing in the processing apparatus 10 are similar to those according to the first example embodiment.

As described above, the processing apparatus 10 according to the present example embodiment provides advantageous effects similar to those provided by the processing apparatus 10 according to the first example embodiment. Further, the processing apparatus 10 according to the present example embodiment can perform the determination processing by the determination unit 13 only on a required product, and therefore can lighten loads on the computer and an operator.

### Third Example Embodiment

A configuration of a determination unit 13 in a processing apparatus 10 according to the present example embodiment differs from that according to the first and second example embodiments. The difference will be described below.

An example of a functional block diagram of the processing apparatus 10 is illustrated in FIG. 1. The processing apparatus 10 includes an acquisition unit 11, a retrieval unit 12, the determination unit 13, a processing unit 14, and a memory unit 15. Note that the processing apparatus 10 may not include the memory unit 15. In this case, an external apparatus configured to be communicable with the processing apparatus 10 includes the memory unit 15.

Based on a degree of similarity between an image of a retrieved product in a shelf image and an image of the retrieved product registered in a product database, the determination unit 13 determines existence of a difference between the two images. For example, the determination unit 13 may determine that a difference exists between the two images when the degree of similarity is greater than M1 and less than M3 (where M2>M3>M1). While details of M1 and M3 are a matter of design, for example when a degree of similarity is indicated by a value ranging from 0 to 100%, M1 may take any value between 80 and 90%, and M3 may take any value between 80 and 93%.

Configurations of the acquisition unit 11, the retrieval unit 12, the processing unit 14, and the memory unit 15 are similar to those according to the first example embodiment. Furthermore, an example of a hardware configuration of and an example of a flow of processing in the processing apparatus 10 are similar to those according to the first example embodiment.

As described above the processing apparatus 10 according to the present example embodiment provides advantageous effects similar to those provided by the processing apparatus 10 according to the first example embodiment. Further, the processing apparatus 10 according to the present example embodiment can automate the determination processing by the determination unit 13 and therefore can lighten a load on an operator.

### Fourth Example Embodiment

Configurations of a retrieval unit 12 and a processing unit 14 in a processing apparatus 10 according to the present example embodiment differ from those according to the first to third example embodiments. The difference will be described below.

An example of a functional block diagram of the processing apparatus 10 is illustrated in FIG. 1. The processing apparatus 10 includes an acquisition unit 11, the retrieval unit 12, a determination unit 13, the processing unit 14, and a memory unit 15. Note that the processing apparatus 10 may not include the memory unit 15. In this case, an external apparatus configured to be communicable with the processing apparatus 10 includes the memory unit 15.

Based on images of a plurality of products registered in a product database, the retrieval unit 12 retrieves, in a shelf image, a similar product for which a degree of similarity with a product registered in the product database is equal to or greater than a predetermined value although the similar product is not registered in the product database. For example, by retrieving, by pattern matching based on images of a plurality of products registered in the product database, an area in the shelf image for which a degree of similarity with an image of each product registered in the product database is equal to or greater than a predetermined value M4 and less than M1 (where M1>M4), the retrieval unit 12 determines an area in the shelf image in which a similar product exists. While details of M1 and M4 are a matter of design, for example, when a degree of similarity is indicated by a value ranging from 0 to 100%, M1 may take any value between 80 and 90%, and M4 may take any value between 60 and 80%.

The processing unit 14 notifies an operator of a similar product. Specifically, the processing unit 14 notifies the operator of existence of a similar product not being registered in the product database but being similar to a product registered in the product database. In the notification, the processing unit 14 may output an image of the similar product in the shelf image. Further, the processing unit 14 may notify the operator of information for identifying a product determined to be similar to the similar product out of the products registered in the product database. Note that the processing unit 14 may register the similar product and make the aforementioned notification, based on the registered content, at any timing.

The processing unit 14 provides the notification through any output apparatus such as a display, a speaker, a mailer, or a printer.

The remaining configurations of the retrieval unit 12 and the processing unit 14 are similar to those according to the first example embodiment. Further, configurations of the acquisition unit 11, the determination unit 13, and the memory unit 15 are similar to those according to one of the first to third example embodiments. Furthermore, an example of a hardware configuration of and an example of a flow of processing in the processing apparatus 10 are similar to those according to the first example embodiment.

As described above, the processing apparatus 10 according to the present example embodiment provides advantageous effects similar to those provided by the processing apparatuses 10 according to the first to third example embodiments. Further, the processing apparatus 10 according to the present example embodiment can retrieve, in a shelf image, a similar product not being registered in the product database but being similar to a product registered in the product database and can notify an operator of the similar product.

A product not registered in the product database is not expected to be recognized in the processing of recognizing and registering a product to be checked out, based on a captured image of the product to be checked out and preregistered reference images of products. However, when the product to be checked out is a similar product similar to a product registered in the product database, the similar product may be incorrectly recognized as another product. The processing apparatus 10 according to the present example embodiment can retrieve a product (similar product) that may be thus incorrectly recognized and needs to be promptly registered in the product database and notify an operator of the product.

### Fifth Example Embodiment

A processing apparatus according to the present example embodiment is equipped with a function for enabling an operator to recognize existence of a product not registered in a product database, based on a shelf image including a shelf on which products are displayed. Details will be described below.

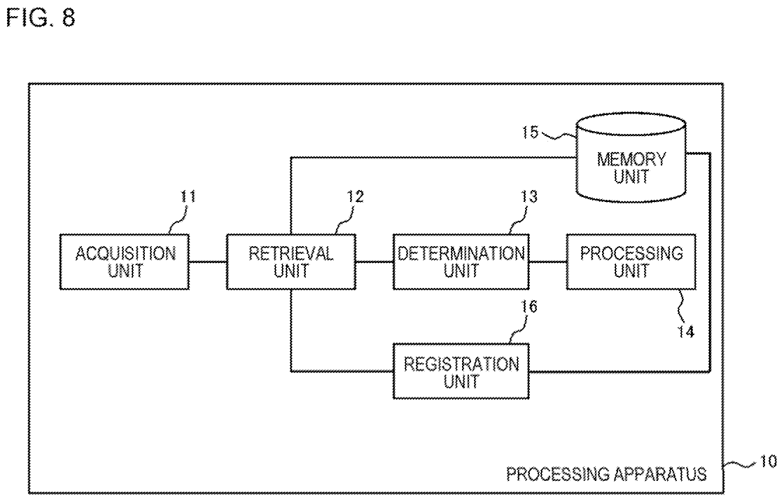

FIG. 8 illustrates an example of a functional block diagram of a processing apparatus 10. As illustrated, the processing apparatus 10 includes an acquisition unit 11, a retrieval unit 12, a determination unit 13, a processing unit 14, a memory unit 15, and a registration unit 16. Note that the processing apparatus 10 may not include the memory unit 15. In this case, an external apparatus configured to be communicable with the processing apparatus 10 includes the memory unit 15.

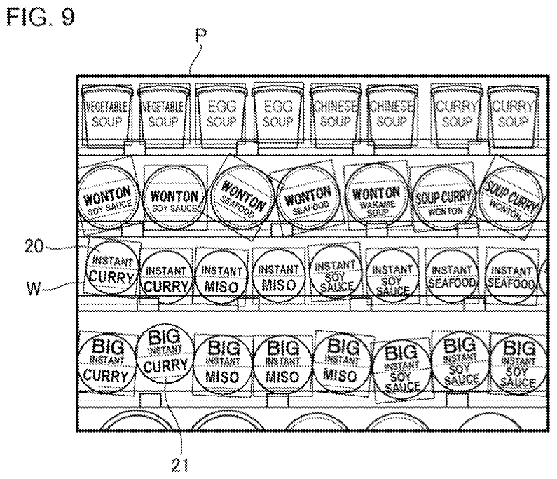

The registration unit 16 notifies an operator of a product not registered in the product database out of products included in a shelf image. For example, the registration unit 16 makes the notification by causing a display apparatus to display a screen indicating a shelf image and a frame W superimposed on the shelf image, as illustrated in FIG. 9. The frame W is displayed correspondingly to a display area of a “product registered in the product database,” the product being retrieved by the retrieval unit 12. For example, a frame W surrounding the display area may be displayed. Such a screen can notify an operator of a product 21 for which a related frame W is not displayed out of the products included in the shelf image as a product not registered in the product database.

Note that the registration unit 16 may determine an area in which a product not registered in the product database exists out of the products included in the shelf image and register an image in the determined area in the product database as an image of a new product. For example, the registration unit 16 may determine an area specified by an operator in the shelf image as an area in which a product not registered in the product database exists. Note that the registration unit 16 may register an image of a new product in association with product identification information input by a user.

Configurations of the acquisition unit 11, the retrieval unit 12, the determination unit 13, the processing unit 14, and the memory unit 15 are similar to those according to one of the first to fourth example embodiments. Furthermore, an example of a hardware configuration of and an example of a flow of processing in the processing apparatus 10 are similar to those according to the first example embodiment.

As described above, the processing apparatus 10 according to the present example embodiment provides advantageous effects similar to those provided by the processing apparatuses 10 according to the first to fourth example embodiments. Further, the processing apparatus 10 according to the present example embodiment can notify an operator of a product not registered in the product database out of products included in a shelf image. Therefore, the operator can easily recognize a product being displayed on the shelf but not being registered in the product database.

### Sixth Example Embodiment

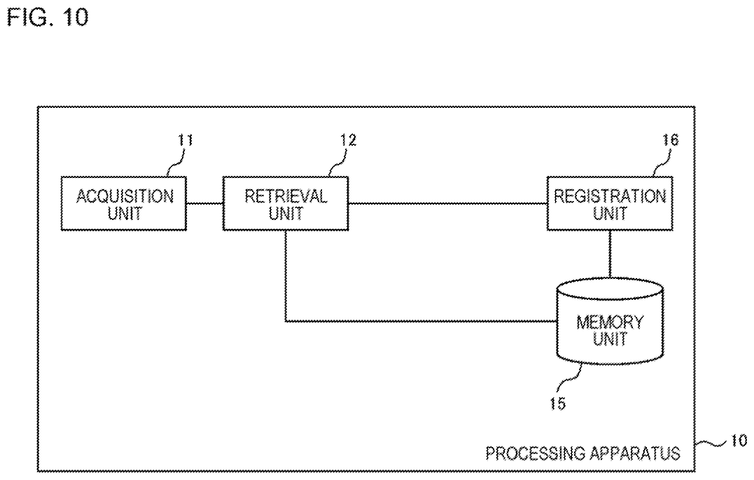

FIG. 10 illustrates an example of a functional block diagram of a processing apparatus 10 according to the present example embodiment. As illustrated, the processing apparatus 10 includes an acquisition unit 11, a retrieval unit 12, a memory unit 15, and a registration unit 16. Note that the processing apparatus 10 may not include the memory unit 15. In this case, an external apparatus configured to be communicable with the processing apparatus 10 includes the memory unit 15.

Configurations of the acquisition unit 11, the retrieval unit 12, the memory unit 15, and the registration unit 16 are similar to those according to one of the first to fifth example embodiments. Furthermore, an example of a hardware configuration of and an example of a flow of processing in the processing apparatus 10 are similar to those according to the first example embodiment.

As described above, the processing apparatus 10 according to the present example embodiment can provide advantageous effect similar to those provided by the processing apparatuses 10 according to the first to fifth example embodiments.

While the present invention has been particularly shown and described with reference to example embodiments (and examples) thereof, the invention is not limited to these example embodiments (and examples). It will be understood by a person skilled in the art that various changes in form and details may be made therein without departing from the spirit and scope of the present invention as defined by the claims.

A part or the whole of the aforementioned example embodiments may also be described as the following supplementary notes but is not limited thereto.
1. A processing apparatus including:

an acquisition means for acquiring a shelf image including a shelf on which a product is displayed;

a retrieval means for retrieving, in the shelf image, a product registered in a product database, based on an image of each of a plurality of products registered in the product database;

a determination means for determining a difference between an image of a retrieved product in the shelf image and an image of the retrieved product registered in the product database; and

a processing means for notifying a product for which a difference is determined to exist.
2. The processing apparatus according to 1, wherein

the determination means causes a display apparatus to display the image of the retrieved product in the shelf image and the image of the retrieved product registered in the product database and then accepts a user input indicating the difference.
3. The processing apparatus according to 1, wherein

the determination means determines the difference, based on a degree of similarity between the image of the retrieved product in the shelf image and the image of the retrieved product registered in the product database.
4. The processing apparatus according to any one of 1 to 3, wherein,

when a degree of similarity between the image of the retrieved product in the shelf image and the image of the retrieved product registered in the product database does not satisfy a predetermined condition, the determination means determines the difference.
5. The processing apparatus according to any one of 1 to 4, wherein

the processing means registers, in the product database, the image of the product in the shelf image for which a difference is determined to exist.
6. The processing apparatus according to any one of 1 to 5, wherein,

based on an image of each of a plurality of products registered in the product database, the retrieval means retrieves, in the shelf image, a similar product for which a degree of similarity with a product registered in the product database is equal to or greater than a predetermined value although the similar product is not registered in the product database, and

the processing means notifies the similar product.
7. The processing apparatus according to any one of 1 to 6, further including

a registration means for notifying a product not registered in the product database out of one or more products included in the shelf image.
8. The processing apparatus according to 7, wherein

the registration means
determines an area in which a product not registered in the product database out of one or more products included in the shelf image exists and
registers, in the product database, an image inside a determined area.
9. A processing method including, by a computer:

acquiring a shelf image including a shelf on which a product is displayed;

retrieving, in the shelf image, a product registered in a product database, based on an image of each of a plurality of products registered in the product database;

determining a difference between an image of a retrieved product in the shelf image and an image of the retrieved product registered in the product database; and

notifying a product for which a difference is determined to exist.
10. A program causing a computer to function as:

an acquisition means for acquiring a shelf image including a shelf on which a product is displayed;

a retrieval means for retrieving, in the shelf image, a product registered in a product database, based on an image of each of a plurality of products registered in the product database;

a determination means for determining a difference between an image of a retrieved product in the shelf image and an image of the retrieved product registered in the product database; and

a processing means for notifying a product for which a difference is determined to exist.
11. A processing apparatus including:

an acquisition means for acquiring a shelf image including a shelf on which a product is displayed;

a retrieval means for retrieving, in the shelf image, a product registered in a product database, based on an image of each of a plurality of products registered in the product database; and

a registration means for determining an area in which a product not registered in the product database out of one or more products included in the shelf image exists and registering, in the product database, an image inside a determined area.
12. A processing method including, by a computer:

acquiring a shelf image including a shelf on which a product is displayed;

retrieving, in the shelf image, a product registered in a product database, based on an image of each of a plurality of products registered in the product database; and

determining an area in which a product not registered in the product database out of one or more products included in the shelf image exists and registering, in the product database, an image inside a determined area.
13. A program causing a computer to function as:

an acquisition means for acquiring a shelf image including a shelf on which a product is displayed;

a retrieval means for retrieving, in the shelf image, a product registered in a product database, based on an image of each of a plurality of products registered in the product database; and

a registration means for determining an area in which a product not registered in the product database out of one or more products included in the shelf image exists and registering, in the product database, an image inside a determined area.

What is claimed is:

1. A processing apparatus comprising:
at least one memory configured to store one or more instructions; and
at least one processor configured to execute the one or more instructions to:
acquire a shelf image including a shelf on which a product is displayed;
retrieve, in the shelf image, a product registered in a product database, based on an image of each of a plurality of products registered in the product database;
determine a difference between an image of a retrieved product in the shelf image and an image of the retrieved product registered in the product database; and
notify a product for which a difference is determined to exist.

2. The processing apparatus according to claim 1,
wherein the processor is further configured to execute the one or more instructions to cause a display apparatus to display the image of the retrieved product in the shelf image and the image of the retrieved product registered in the product database and then accept a user input indicating the difference.

3. The processing apparatus according to claim 1,
wherein the processor is further configured to execute the one or more instructions to determine the difference, based on a degree of similarity between the image of the retrieved product in the shelf image and the image of the retrieved product registered in the product database.

4. The processing apparatus according to claim 1,
wherein the processor is further configured to execute the one or more instructions to determine the difference, when a degree of similarity between the image of the retrieved product in the shelf image and the image of the retrieved product registered in the product database does not satisfy a predetermined condition.

5. The processing apparatus according to claim 1,
wherein the processor is further configured to execute the one or more instructions to register, in the product database, the image of the product in the shelf image for which a difference is determined to exist.

6. The processing apparatus according to claim 1, wherein the processor is further configured to execute the one or more instructions to:
based on an image of each of a plurality of products registered in the product database, retrieve, in the shelf image, a similar product for which a degree of similarity with a product registered in the product database is equal to or greater than a predetermined value although the similar product is not registered in the product database, and
notify the similar product.

7. The processing apparatus according to claim 1,
wherein the processor is further configured to execute the one or more instructions to notify a product not registered in the product database out of one or more products included in the shelf image.

8. The processing apparatus according to claim 7, wherein the processor is further configured to execute the one or more instructions to:
determine an area in which a product not registered in the product database out of one or more products included in the shelf image exists and
register, in the product database, an image inside a determined area.

9. A processing method comprising, by a computer:
acquiring a shelf image including a shelf on which a product is displayed;
retrieving, in the shelf image, a product registered in a product database, based on an image of each of a plurality of products registered in the product database;
determining a difference between an image of a retrieved product in the shelf image and an image of the retrieved product registered in the product database; and
notifying a product for which a difference is determined to exist.

10. (canceled)

11. A processing apparatus comprising:
at least one memory configured to store one or more instructions; and
at least one processor configured to execute the one or more instructions to:
acquire a shelf image including a shelf on which a product is displayed;
retrieve, in the shelf image, a product registered in a product database, based on an image of each of a plurality of products registered in the product database; and
determine an area in which a product not registered in the product database out of one or more products included in the shelf image exists and register, in the product database, an image inside a determined area.

12. (canceled)

13. (canceled)
